(19) United States
(12) Patent Application Publication
(10) Pub. No.: US 2025/0016158 A1
(43) Pub. Date: Jan. 9, 2025

(54) SYSTEM AND METHOD FOR SECURE NETWORK ACCESS MANAGEMENT USING A DYNAMIC CONSTRAINT SPECIFICATION MATRIX

(71) Applicant: BANK OF AMERICA CORPORATION, Charlotte, NC (US)

(72) Inventors: Tomas M. Castrejon, III, Fort Mill, SC (US); James J. Siekman, Charlotte, NC (US); Margaret Elaine Eichorn Thaman, Charlotte, NC (US)

(73) Assignee: BANK OF AMERICA CORPORATION, Charlotte, NC (US)

(21) Appl. No.: 18/219,404

(22) Filed: Jul. 7, 2023

(51) Int. Cl. H04L 9/40

(52) U.S. Cl. CPC H04L 63/10

(57) ABSTRACT

Systems, computer program products, and methods are described herein for secure network access management using a dynamic constraint specification matrix. The method includes receiving an application access log associated with a user of a network. The application access log includes one or more approved applications for which the user has access. The method also includes determining a potential malfeasance indication for the user based on the application access log. The potential malfeasance indication is based on a first application of the one or more approved applications and a second application of the one or more approved applications that correspond to one of one or more potential malfeasant approval combinations. Each of the one or more potential malfeasant approval combinations includes two or more applications that one or more users on the network should not be authorized for access simultaneously. The method further includes causing an execution of an investigation action.

### TECHNOLOGICAL FIELD

Example embodiments of the present disclosure relate generally to monitoring network access and, more particularly, to secure network access management using a dynamic constraint specification matrix.

### BACKGROUND

In a large computing environment with numerous interconnected end-point systems, it can be difficult to track instances in which application permissions cause potential vulnerabilities to the system. Applicant has identified a number of deficiencies and problems associated with timely detection of potentially unauthorized access, system errors, or data loss events. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for secure network access management using a dynamic constraint specification matrix. In an example embodiment, a system for secure network access management using a dynamic constraint specification matrix is provided. The system includes at least one non-transitory storage device containing instructions and at least one processing device coupled to the at least one non-transitory storage device. The at least one processing device, upon execution of the instructions, is configured to receive an application access log associated with a user of a network. The application access log includes one or more approved applications for which the user has access. The at least one processing device, upon execution of the instructions, is also configured to determine a potential malfeasance indication for the user based on the application access log. The potential malfeasance indication is based on a first application of the one or more approved applications and a second application of the one or more approved applications that correspond to one of one or more potential malfeasant approval combinations. Each of the one or more potential malfeasant approval combinations includes two or more applications that one or more users on the network should not be authorized for access simultaneously. The at least one processing device, upon execution of the instructions, is configured to cause an execution of an investigation action. The investigation action determines whether access for at least one of the first application or the second application was approved for the user

In various embodiments, the at least one processing device, upon execution of the instructions, is configured to determine the one or more potential malfeasant approval combinations with each of the one or more potential malfeasant approval combinations including two or more applications that one or more users on the network should not be authorized for access simultaneously.

In various embodiments, the at least one processing device, upon execution of the instructions, is configured to determine a usage amount for at least one of the first application or the second application by the user with the usage amount indicating an amount that given application was accessed, used, or opened on an end-point device associated with the user.

In various embodiments, the at least one processing device, upon execution of the instructions, is configured to receive application activity information for at least one of the first application or the second application with the application activity information including one or more actions taken by an end-point device associated with the user on at least one of the first application or the second application; and determine a potential malfeasant activity based on the application activity information.

In various embodiments, the at least one processing device, upon execution of the instructions, is configured to determine an access change action with the access change action including changing access for the user to at least one of the first application or the second application.

In various embodiments, the access change action is based on the execution of the investigation action and access for the user to at least one of the first application or the second application is restricted in an instance at least one of the first application or the second application was not approved for the user.

In various embodiments, the at least one processing device, upon execution of the instructions, is configured to determine an access change action with the access change action including changing access for the user to at least one of the first application or the second application in an instance in which the potential malfeasant activity is determined.

In another example embodiment, a computer program product for secure network access management using a dynamic constraint specification matrix is provided. The computer program product includes at least one non-transitory computer-readable medium having computer-readable program code portions embodied therein. The computer-readable program code portions include one or more executable portions configured to receive an application access log associated with a user of a network. The application access log includes one or more approved applications for which the user has access. The computer-readable program code portions include one or more executable portions also configured to determine a potential malfeasance indication for the user based on the application access log. The potential malfeasance indication is based on a first application of the one or more approved applications and a second application of the one or more approved applications that correspond to one of one or more potential malfeasant approval combinations. Each of the one or more potential malfeasant approval combinations includes two or more applications that one or more users on the network should not be authorized for access simultaneously. The computer-readable program code portions include one or more executable portions further configured to cause an execution of an investigation action. The investigation action determines whether access for at least one of the first application or the second application was approved for the user.

In various embodiments, the computer-readable program code portions include one or more executable portions are also configured to determine the one or more potential malfeasant approval combinations with each of the one or more potential malfeasant approval combinations including two or more applications that one or more users on the network should not be authorized for access simultaneously.

In various embodiments, the computer-readable program code portions include one or more executable portions are also configured to determine a usage amount for at least one of the first application or the second application by the user with the usage amount indicating an amount that given application was accessed, used, or opened on an end-point device associated with the user.

In various embodiments, the computer-readable program code portions include one or more executable portions are also configured to receive application activity information for at least one of the first application or the second application with the application activity information including one or more actions taken by an end-point device associated with the user on at least one of the first application or the second application; and determine a potential malfeasant activity based on the application activity information.

In various embodiments, the computer-readable program code portions include one or more executable portions are also configured to determine an access change action with the access change action including changing access for the user to at least one of the first application or the second application.

In various embodiments, the access change action is based on the execution of the investigation action and access for the user to at least one of the first application or the second application is restricted in an instance at least one of the first application or the second application was not approved for the user.

In various embodiments, the computer-readable program code portions include one or more executable portions are also configured to determine an access change action with the access change action including changing access for the user to at least one of the first application or the second application in an instance in which the potential malfeasant activity is determined.

In still another example embodiment, a method for secure network access management using a dynamic constraint specification matrix is provided. The method includes receiving an application access log associated with a user of a network. The application access log includes one or more approved applications for which the user has access. The method also includes determining a potential malfeasance indication for the user based on the application access log. The potential malfeasance indication is based on a first application of the one or more approved applications and a second application of the one or more approved applications that correspond to one of one or more potential malfeasant approval combinations. Each of the one or more potential malfeasant approval combinations includes two or more applications that one or more users on the network should not be authorized for access simultaneously. The method further includes causing an execution of an investigation action. The investigation action determines whether access for at least one of the first application or the second application was approved for the user.

In various embodiments, the method also includes determining the one or more potential malfeasant approval combinations with each of the one or more potential malfeasant approval combinations including two or more applications that one or more users on the network should not be authorized for access simultaneously.

In various embodiments, the method also includes determining a usage amount for at least one of the first application or the second application by the user with the usage amount indicating an amount that given application was accessed, used, or opened on an end-point device associated with the user.

In various embodiments, the method also includes receiving application activity information for at least one of the first application or the second application with the application activity information including one or more actions taken by an end-point device associated with the user on at least one of the first application or the second application; and determining a potential malfeasant activity based on the application activity information.

In various embodiments, the method also includes determining an access change action with the access change action including changing access for the user to at least one of the first application or the second application, in an instance at least one of the first application or the second application was not approved for the user.

In various embodiments, the method also includes determining an access change action with the access change action including changing access for the user to at least one of the first application or the second application in an instance in which the potential malfeasant activity is determined.

To facilitate the process of more efficient and effective detection of potentially unauthorized access, system errors, or data loss events within large computing environments, the present disclosure offers various systems and methods for employing data aggregators such as Security Information and Event Management (SIEM) systems, which collect, normalize, and correlate data from various sources, providing a centralized platform for security monitoring and analysis. By integrating Artificial Intelligence (AI) and Machine Learning (ML) techniques into the SIEM system, the present disclosure enhances entity ability to process large volumes of aggregated data, efficiently identifying patterns that could be indicative of potential threats, issues or anomalies.

While AI/ML techniques have proven effective in identifying patterns within large datasets, they often require external input to determine the significance of the identified patterns. Human expertise and domain-specific knowledge remain essential in interpreting the results generated by AI/ML models, discerning whether the detected patterns indicate potential threats, or anomalies. This collaboration between AI/ML systems and human analysts ensures a more comprehensive and accurate understanding of the computing environment's security landscape. By combining the strengths of AI/ML's processing capabilities with human intuition and contextual understanding, entities can employ various embodiments of the present disclosure to enhance overall security posture, allowing for more informed decisions and more effective response to potential issues and system vulnerabilities.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an example distributed computing environment for secure network access management using a dynamic constraint specification matrix, in accordance with various embodiments of the present disclosure;

FIG. 2 illustrates an example machine learning (ML) subsystem architecture 200 used in accordance with various embodiments of the present disclosure; and

FIG. 3 illustrates a process flow for secure network access management using a dynamic constraint specification matrix, in accordance with various embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data. An “entity” can encompass a wide range of organizations, such as institutions, groups, associations, financial institutions, establishments, companies, unions, authorities, and similar entities. The common factor among these entities is their utilization of information technology resources for processing substantial amounts of data. As such, an “entity” in this context denotes any organization or institution that employs information technology resources capable of processing large volumes of data, which can pertain to different aspects of the entity's operations.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device. Additionally, as used herein, a “resource” may also encompass computing or network resources. This broader definition of a resource includes elements such as computational power, storage capacity, network bandwidth, software applications, databases, virtual machines, servers, routers, switches, and other similar components associated with computing or network infrastructure.

As used herein, a “template” refers to a pre-formatted, customizable document or tool that provides a structured approach to identifying, evaluating, and addressing security threats. A security assessment template typically consists of a set of predefined sections, fields, or criteria that guide users through the process of conducting a comprehensive security or threat assessment. In some embodiments, each section of the template corresponds to a specific aspect or step of the assessment process. In some embodiments, a section includes fields for documenting the information or system components that the assessment covers. This may include hardware, software, data, networks, and human resources. In some embodiments, a section may include a list of users or document potential threats to each user. Threats could be anything that could utilize a vulnerability to cause harm to the system. In some embodiments, a section may include identifying data and documentation for potential vulnerabilities that threats could utilize. Vulnerabilities could range from weak passwords and out-of-date software to inadequate security policies or data storage methods. In some embodiments, a section may include fields for evaluating and rating the possibility or likelihood associated with each threat and vulnerability combination. In some embodiments, this involves considering the potential impact of the threat or vulnerability and the likelihood of it occurring. In some embodiments, a section may include documented strategies for mitigating each threat. This could include a range of actions from patching software vulnerabilities and improving security policies to investing in new security technologies. In some embodiments, a section may include an area to note when the assessment was conducted, who conducted it, and when it will be reviewed and updated next. In some embodiments, a section may include a starting point and can be customized according to the specific needs and context of an organization. By following a structured approach, security assessment templates help ensure that all relevant factors are considered, which leads to more accurate assessments and more effective mitigation strategies.

As used herein, an “artificial intelligence” (AI) system is a computing framework designed to perform tasks that normally require human intelligence, such as understanding natural language, recognizing patterns, problem-solving, and making decisions. It is understood that these systems operate by mimicking the neural networks of humans in a simplified form. In some embodiments, they may consist of interconnected layers of nodes, often referred to as artificial neurons, that process information using dynamic state responses to external inputs. They are trained by feeding them large volumes of data and adjusting the connections between the nodes using complex mathematical algorithms based on the principles of statistics and calculus, allowing them to learn from this data. In some embodiments, an AI system may be stored and executed in various ways depending on the requirements of the specific implementation. It is understood that AI systems can be hosted on local machines, in data centers, or in the cloud. It is further understood that cloud-based AI systems are becoming increasingly common due to their scalability, cost-effectiveness, and the ability to handle vast amounts of data. AI systems may be employed for identifying data patterns and vulnerability vectors due to their ability to analyze large and complex datasets rapidly and accurately.

As used herein “machine learning” (ML), a subset of AI, may be utilized in some embodiments. ML algorithms learn from the data they process, enabling them to discover hidden insights and patterns that may not be apparent to human analysts. For instance, in cybersecurity, AI systems can analyze network traffic to identify patterns consistent with cyber threats or vulnerabilities, providing an effective tool for proactively safeguarding systems and data. It is understood that there are several types of ML algorithms, each suited to different types of tasks. These include supervised learning where the algorithm learns from labeled training data, and then applies what it has learned to new data. In further embodiments, unsupervised learning may employ unlabeled data and learn by identifying patterns and structures within it. Additionally, in some embodiments, reinforcement learning may involve an algorithm that learns by interacting with its environment and receives rewards or demerits based on its actions. Furthermore, semi-supervised learning may include a blend of supervised and unsupervised learning wherein various embodiments of the present disclosure employ the use of an algorithm which learns from a small amount of labeled data supplemented by a large amount of unlabeled data. Particularly regarding cybersecurity, ML may be used to identify patterns consistent with cyber vulnerabilities. The ML algorithm of various embodiments may analyze network traffic data, system logs, user behavior, or the like, and learn what “normal” activity looks like on an entity network infrastructure. Once the model has been trained on this data, it can then monitor network activity and identify anomalies or deviations from the normal pattern. These anomalies could potentially be cyber vulnerabilities, such as an intrusion, malicious activity, or use of a software vulnerability. This proactive approach to cybersecurity allows vulnerabilities to be detected and mitigated early, reducing the potential damage they may cause. In some embodiments, ML may provide valuable insights and automated decision-making capabilities across multiple entity communication channels.

In large computing environments with numerous interconnected end-point systems, it is crucial to gather diverse information, including system events, malware type events, and component malfunction events, to ensure comprehensive monitoring and timely detection of potentially unauthorized access, system errors, or data loss events. There are a number of deficiencies and problems associated with timely detection of potentially unauthorized access, system errors, or data loss events with respect to conventional solutions.

To facilitate the process of more efficient and effective detection of potentially unauthorized access, system errors, or data loss events within large computing environments, embodiments of the present disclosure offer various systems and methods for employing data aggregators such as Security Information and Event Management (SIEM) systems, which collect, normalize, and correlate data from various sources, providing a centralized platform for security monitoring and analysis. By integrating Artificial Intelligence (AI) and Machine Learning (ML) techniques into the SIEM system, various embodiments of the present disclosure enhance entity ability to process large volumes of aggregated data, efficiently identifying patterns that could be indicative of potential issues or anomalies.

While AI/ML techniques have proven effective in identifying patterns within large datasets, they often require external input to determine the significance of the identified patterns. Human expertise and domain-specific knowledge remain essential in interpreting the results generated by AI/ML models, discerning whether the detected patterns indicate potential threats, or anomalies. This collaboration between AI/ML systems and human analysts ensures a more comprehensive and accurate understanding of the computing environment's security landscape. By combining the strengths of AI/ML's processing capabilities with human intuition and contextual understanding, entities can employ embodiments of the present disclosure to enhance overall security posture, allowing for more informed decisions and more effective response to potential issues and system vulnerabilities.

Embodiments of the present disclosure incorporate human expertise and domain-specific knowledge into a dynamic template with multiple parameters tailored to identify specific scenarios when a pattern is indicative of a system vulnerability. This dynamic template, referred to as a “Constraint Specification Matrix,” can adapt to evolving landscapes, allowing entities to refine and adjust the parameters (e.g., vulnerability vectors, or the like) based on real-world experiences and emerging trends. By continuously updating and optimizing the Constraint Specification Matrix, entities can ensure that the AI/ML-based systems remain relevant and effective in detecting vulnerabilities and protecting against known vulnerabilities. This collaborative approach, combining the strengths of human intuition with the processing capabilities of AI/ML, creates a more robust and agile security posture, empowering entities to respond proactively to the ever-changing cybersecurity landscape.

The Constraint Specification Matrix template is system agnostic and serves as tool for evaluating the likelihood of a vulnerability occurring within any computing environment depending on the type of data generated by the computing environment. By incorporating a diverse array of parameters sourced from domain-specific knowledge, industry best practices, and real-time data analysis, the template enables entities to assess potential vulnerabilities with greater precision and accuracy.

In various embodiments, the system leverages a Constraint Specification Matrix template that can be designed with a base set of parameters that apply to the computing environment, as well as temporary versions tailored to address significant changes, such as change in vulnerability vectors, code patches, version updates, or infrastructure modifications to the computing environment. These temporary versions incorporate parameters specific to the changes, enabling the entity to closely monitor and assess any potential vulnerabilities arising from the updates. Over time, these temporary versions can be phased out automatically based on predefined constraints indicating that the updated components have stabilized and integrated well with the overall computing environment. This flexible and adaptive approach ensures that the template remains relevant and effective in addressing both persistent and transient vulnerabilities.

Furthermore, various embodiments offer the ability to customize the dynamic Constraint Specification Matrix to include parameters specific to a computing environment, ensuring a bespoke approach to security monitoring and vulnerability detection. In the context of access management and authentication, the data aggregator (e.g., a Business Rules Engine (BRE), or the like) can aggregate data related to login attempts, user privileges, and other relevant events from the computing environment. For example, each of these data elements may be retrieved from a System of Record (SOR) published by the computing environment. By employing AI/ML techniques, patterns within this data can be identified, offering insights into potential vulnerabilities, such as unauthorized access or privilege escalation attempts. The template's parameters, fine-tuned for the unique characteristics of the computing environment, can then be used to determine whether a detected pattern (e.g., toxic combination of access privileges, or the like) is indicative of a genuine vulnerability or simply a benign activity. Furthermore, the Constraint Specification Matrix can include parameters related to behavioral patterns of access privilege assignments across the computing environment, offering insights into specific actions executed by users to provide other users (or themselves) access to resources within the computing environment that may indicate malfeasant action. This adaptive and context-aware approach enables entities to focus their security efforts more effectively, enhancing their ability to proactively detect and respond to potential vulnerabilities in a timely manner.

Additionally, embodiments of the present disclosure may employ AI/ML to identify a likelihood of a case contributing to a loss based on a database of historical cases. By utilizing case data (e.g., date, geographic location, line of business, communication channel, or the like) from historical cases that are known to have caused a loss, AI/ML models can analyze historical patterns and trends to predict potential vulnerabilities. User input labeling known cases that resulted in a loss can help train the AI/ML models, enhancing their accuracy and effectiveness in identifying cases with a high percentage likelihood of vulnerability manifestation. The output generated by these models is a likelihood score that indicates the probability of a case contributing to a loss, enabling organizations to preempt the need for mitigation. By proactively addressing cases with high likelihood scores before they escalate into actual losses, entities can optimize their vulnerability management strategies, reduce financial exposure, and maintain a more secure and resilient operational environment.

In order to effectively initiate remedial actions based on the likelihood of a case contributing to a loss, a threshold can be assigned to serve as a decision-making criterion. This threshold value represents a specific level of likelihood that the entity deems significant enough to warrant intervention. By comparing the likelihood scores generated by the AI/ML models against the predefined threshold, organizations can determine whether a case's likelihood level necessitates immediate remedial action. This approach ensures that resources are allocated efficiently and that remedial actions are focused on cases that pose the greatest vulnerability to the entity's financial stability and operational integrity. Additionally, the threshold value can be fine-tuned over time based on changing landscapes and entity priorities, enabling a more agile and adaptive vulnerability management strategy.

Networks often have a large number of users, which make monitoring each user for malfeasant behavior cumbersome and difficult. Additionally, users may have network access settings that allow for malfeasant behavior to more easily be completed by a user. However, it is difficult for a system to monitor for such security issues.

Various embodiments of the present disclosure provide a system for secure network access management using a dynamic constraint specification matrix. To do this, the system monitors user access settings to determine potential malfeasant issues. The system monitors for instances in which a user has access to one or more potential malfeasant approval combinations. Each potential malfeasant approval combinations includes two or more applications that a user should not be authorized for access simultaneously. For example, certain applications may be used in combination by a user to create malfeasant attacks. In an instance in which a user is determined to have access to a first application and a second application, which are grouped together as a potential malfeasant approval combination, the system is configured to cause an investigation action to be executed. The investigation action may be various actions, such as determining whether the user got approval for the applications from a supervisor, monitoring user actions to determine whether any malfeasant actions are being taken by the user, and/or the like.

What is more, the present disclosure provides a technical solution to a technical problem. As described herein, the technical problem includes the difficulty in identifying and managing vulnerabilities in complex and dynamic computing environments, which often results in delayed responses to potential vulnerabilities, leading to security breaches, financial losses, and operational disruption.

The technical solution presented herein allows for the use of a dynamic, AI/ML-based system that continuously adapts to changing landscapes and optimizes its performance based on real-world experiences and emerging trends. This system employs a Constraint Specification Matrix, a tool that combines human expertise and domain-specific knowledge with machine learning capabilities to accurately identify vulnerability vectors and predict potential system vulnerabilities. In particular, this AI/ML-based system is an improvement over existing solutions to the problem of vulnerability detection and management. It accomplishes this (i) with fewer steps to achieve the solution, thus reducing the amount of computing resources, such as processing resources, storage resources, network resources, and/or the like, that are being used, (ii) providing a more accurate solution to the problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources.

Furthermore, the technical solution described herein uses a rigorous, computerized process to perform specific tasks and/or activities that were not previously performed. In specific implementations, the technical solution bypasses a series of steps previously implemented, thus further conserving computing resources. The introduction of the dynamic Constraint Specification Matrix as an adaptable tool in the workflow represents a significant leap forward, as it streamlines the process of vulnerability detection and enables a more proactive and precise approach to cybersecurity management.

Additionally, the receipt, correlation, and enhancement of data via the dynamic Constraint Specification Matrix as an adaptable tool in the workflow as described herein enables load distribution by allowing data to be stored at individual data sources in a distributed manner. Previous systems require that all applicable information is hosted at one central location, which requires massive databases and increases network traffic as data continuously flows from each data source to the central server. In contrast, the distributed storage described herein reduces network congestion with its ability to monitor data from multiple different channels, while still allowing the data to be accessible as needed to achieve the features and functions of the system. One of ordinary skill in the art will appreciate that the system utilizes actual data of the system as it is monitored, rather than relying on additionally generated data metrics or metadata, which results in an efficient approach reducing the load on the entity system as compared to conventional solutions.

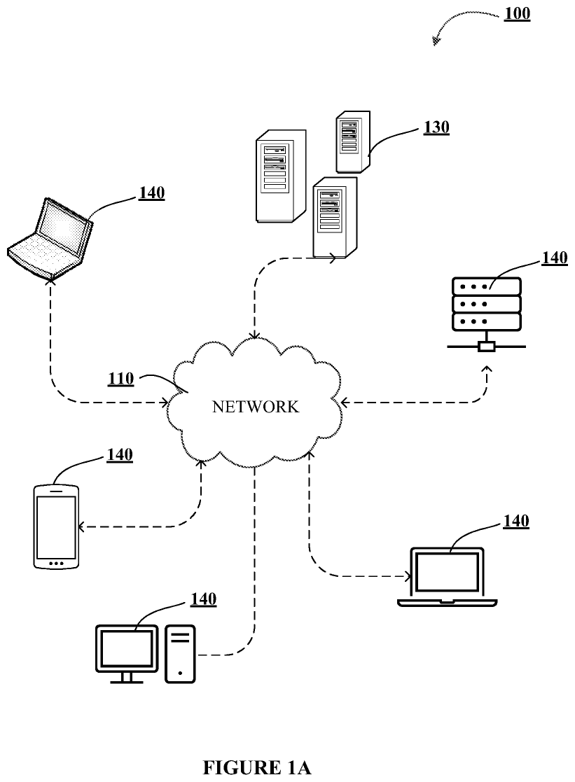

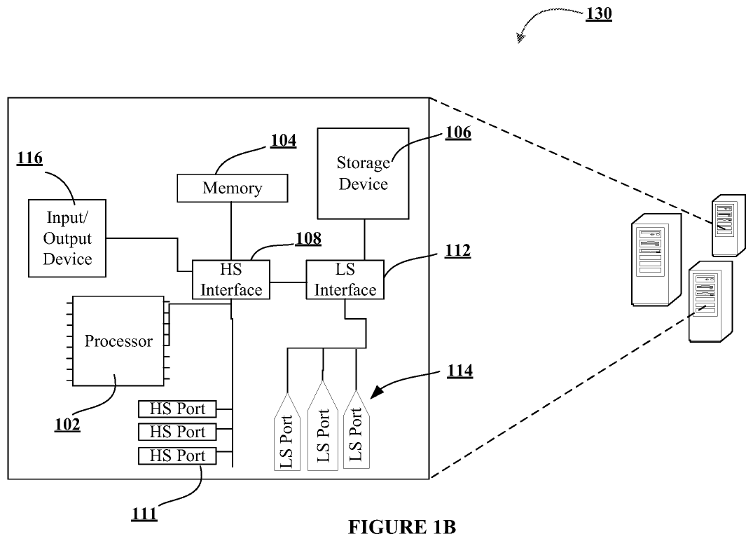

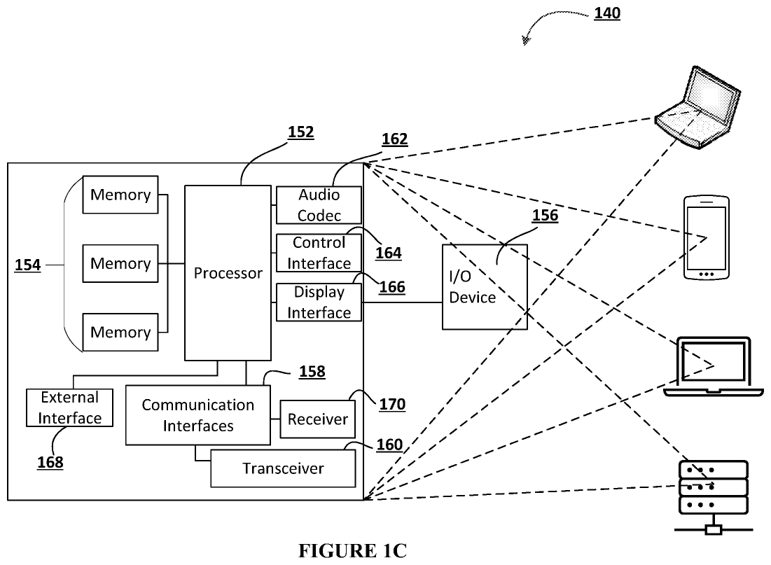

FIGS. 1A-1C illustrate technical components of an example distributed computing environment for secure network access management using a dynamic constraint specification matrix, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, a satellite network, a cellular network, and/or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an example component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 (shown as “LS Interface”) connecting to the memory 104, and a low-speed interface 112 connecting to low-speed expansion port 114 (shown as “LS Port”) and storage device 106. Each of the components 102, 104, 106, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-readable or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 (shown as “HS interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an example component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

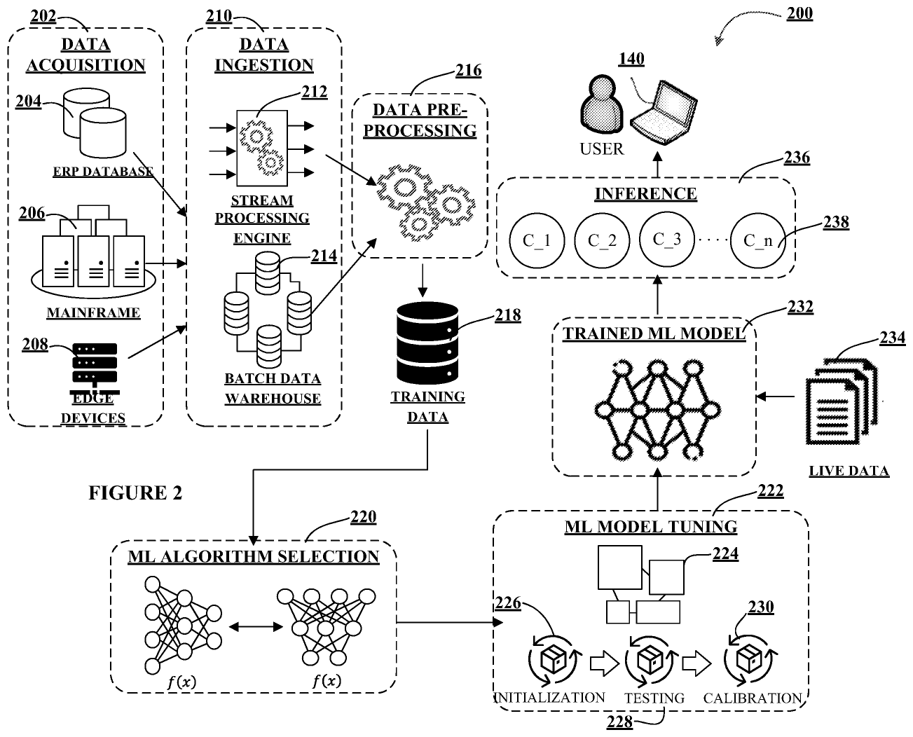

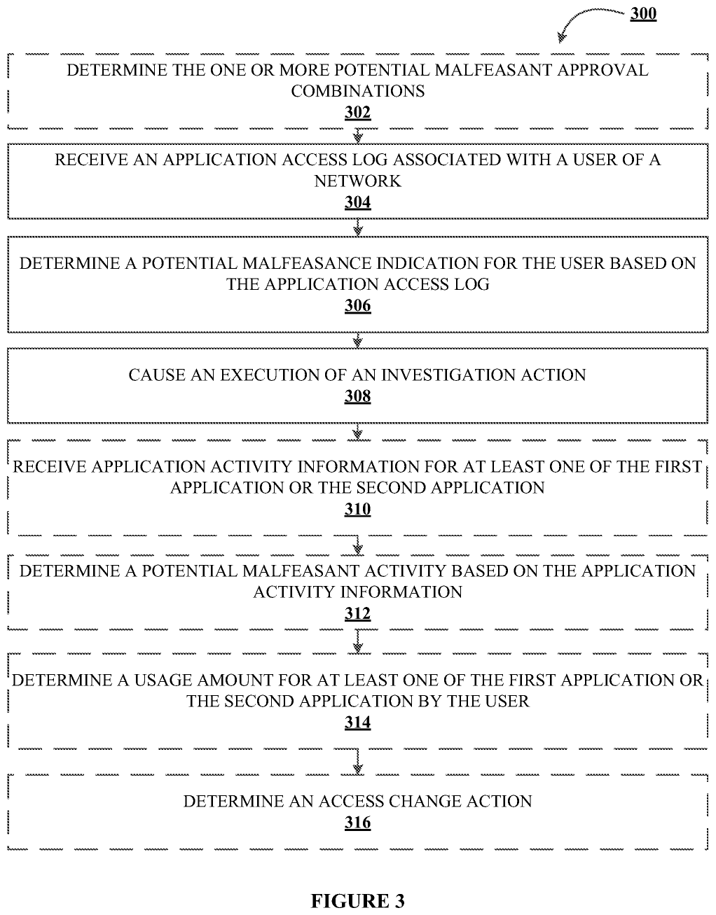

FIG. 2 illustrates an example machine learning (ML) subsystem architecture 200, in accordance with various embodiments of the present disclosure. The machine learning subsystem 200 may include a data acquisition engine 202, data ingestion engine 210, data pre-processing engine 216, ML model tuning engine 222, and inference engine 236. The ML subsystem architecture 200 may be used to determine patterns in user activity as discussed herein. Additionally or alternatively, the ML subsystem architecture 200 may be used to detect potential malfeasant activity. In various embodiments, the ML subsystem architecture 200 may be used to carry out one or more operations discussed in reference to FIG. 3 below.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 210, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

FIG. 3 illustrates a process flow for secure network access management using a dynamic constraint specification matrix, in accordance with various embodiments of the present disclosure. The method may be carried out by various components of the distributed computing environment 100 discussed herein (e.g., the system 130, one or more end-point devices 140, etc.). An example system may include at least one non-transitory storage device and at least one processing device coupled to the at least one non-transitory storage device. In such an embodiment, the at least one processing device is configured to carry out the method discussed herein. Additionally, ML/AI may also be used, such the AI/ML discussed in reference to FIG. 2.

Referring now to optional Block 302 of FIG. 3, the method includes determining the one or more potential malfeasant approval combinations. In various embodiments, the potential malfeasant approval combinations may be stored in the dynamic constraint specification matrix along with any other parameters for the network. The dynamic constraint specification matrix is customizable, such that potential malfeasant approval combinations may be added, removed, and/or modified within the dynamic constraint specification matrix.

Each of the one or more potential malfeasant approval combinations includes two or more applications that one or more users on the network should not be authorized for access simultaneously. The potential malfeasant approval combinations may be determined in various ways. For example, the potential malfeasant approval combinations may be determined from previous malfeasant activity (e.g., a previous malfeasant user had access to specific applications that allowed for the malfeasant activity to be achieved), predefined rules (e.g., certain users may not be able to access both financial and personal data simultaneously), and/or the like.

Access to an application may be considered access to any portion of an application and/or access may have one or more levels for an application (e.g., a user may have access to a certain portion of an application but is restricted from another portion of the application). As used herein, access to an application may refer to the level of access and can range from no access to full access for an application. As such, a potential malfeasant approval combination may include the access level for one or more of the applications that creates an issue for the network security (e.g., full access to a first application and full access to a second application may threaten network security, but only partial access to one or both applications may not threaten network security).

One or more of the potential malfeasant approval combinations may be determined using ML/AI (e.g., as discussed in reference to FIG. 2). The system may use ML/AI to analyze one or more previous known malfeasant activity to determine potential malfeasant approval combinations. For example, the system may provide the ML/AI with one or more previous known malfeasant activity and the ML/AI components may determine patterns in the access for each user in the given previous known malfeasant activity (e.g., malfeasant activity may be more likely when a user has access to a first application and a second application). As such, the patterns are used to update the dynamic constraint specification matrix. The patterns may include the potential malfeasant approval combinations. Additionally or alternatively, the patterns may include user behavior (e.g., application usage of malfeasant users, application interaction patterns, etc.).

Additionally or alternatively, one or more of the potential malfeasant approval combinations may also be determined without the use of ML/AI. In an example embodiment, one or more of the potential malfeasant approval combinations may be user created (e.g., a system administrator may determine that one or more users in a network should not have access to certain applications together). In some embodiments, potential malfeasant approval combinations may be generated based on rules and/or regulations relating to data. For example, one or more users may be restricted from having access to different types of data, as in combination the data may be used for malfeasance (e.g., a network may have multiple applications that together may be used for malfeasance).

In various embodiments, one or more of the potential malfeasant approval combinations may be specific to one or more users within the network. For example, lower-level users (e.g., non-management users) may not need to access certain applications to accomplish the function of the user job. In such an example, one or more of the potential malfeasant approval may be one application that the user may need to perform job duties and another application that is not needed to perform job duties.

Referring now to Block 304 of FIG. 3, the method includes receiving an application access log associated with a user of a network. The application access log includes one or more approved applications for which the user has access. The application access log may include whether a user has access to one or more application, the access level of the application for the user, a list of a portion or all of the applications that the user has access, a list of a portion or all of the applications that the user has been denied access, and/or the like.

The application access log may be received as a singular log (e.g., a single file with the application access for one or more users) or the application access log may be received in multiple files (e.g., the application access log may be compiled from multiple communications in which user access is provided). An application access log may be specific to one user or include access information for multiple users. For example, users with the same job titles may have the same application access and the application access log may be uniform for each user with the same job title. In such an example, an application access log may include any changes in access from similar situated users (e.g., the application access log may indicate that a given user is allowed to access a given application that other users with the same job title are not allowed). While the operations are discussed in terms of job title, users within a network may be grouped in various ways that cause the users to have the same (or similar) application access. For example, users may be classified using a security level, which determines the application to which the user has access (e.g., a user with a lower security level may have less access to applications than a user with a higher security level).

In various embodiments, the system may request the application access log for one or more users. For example, the system may periodically monitor users of a network and cause a transmission of a request for an application access log in an instance in which a given user is being monitored. Alternatively, the system may receive the application access log without request. For example, the application access log may be generated and/or provided to the system without prompt (e.g., the system may generate an application access log for a user periodically without prompt).

In various embodiments, the application access log and/or the application activity information discussed in reference to Block 310 may be gathered using a data aggregator. The data aggregator may be part of the system and/or a third party that provides the information to the system. In various embodiments, the data aggregator may gather information relating to user activity, such as login attempts, user privileges, and/or other relevant events from the computing environment. For example, each of these data elements may be retrieved from a System of Record (SOR) published by the computing environment may be used to create the application access log and/or the application activity information. The system may use AI/ML to identify patterns within this data, offering insights into potential threats, such as unauthorized access or privilege escalation attempts. The template's parameters, fine-tuned for the unique characteristics of the computing environment, can then be used to determine whether a detected pattern (e.g., toxic combination of access privileges) is indicative of a genuine threat or simply a benign activity. Furthermore, the Constraint Specification Matrix can include parameters related to behavioral patterns of access privilege assignments across the computing environment, offering insights into specific actions executed by users to provide other users (or themselves) access to resources within the computing environment that may indicate misappropriate action.

Referring now to Block 306 of FIG. 3, the method includes determining a potential malfeasance indication for the user based on the application access log. The potential malfeasance indication is based on a first application of the one or more approved applications and a second application of the one or more approved applications that correspond to one of one or more potential malfeasant approval combinations. As discussed above, the potential malfeasant approval combinations indicate two or more applications that a user should not have access simultaneously. In various embodiments, in an instance in which a user has access to two applications that are a potential malfeasant approval combination, the system may determine that the potential malfeasance indication indicates potential malfeasance. Alternatively, in an instance in which a user does not have access to any potential malfeasant approval combinations, the system may determine that the potential malfeasance indication indicates no potential malfeasance.

In various embodiments, the potential malfeasant indication may cause additional actions (e.g., the investigation action discussed in reference to Block 308 of FIG. 3 below) or a notification to one or more users (e.g., a system administrator may be notified that a given user has a potential malfeasant approval combination).

Referring now to Block 308 of FIG. 3, the method includes causing an execution of an investigation action. The investigation action may include one or more actions used to determine whether the given user should have access to each of the application in the given potential malfeasant approval combination. In various embodiments, the investigation action determines whether access for at least one of the first application or the second application was approved for the user. Namely, the system determines how the user was able to receive access to each of the applications of the potential malfeasant approval combination. For example, the granting of the access may be automatic (e.g., the system automatically approves access requests and/or the system automatically assigns application access to specific user) and/or manual (e.g., a manager or system administrator may approve application access for a user).

In various embodiments, in an instance in which the access approval for the applications of the potential malfeasant approval combination were automated, a network issue may be occurring. As such, the investigation action may adjust the system to not automatically approve such an access. For example, a system may automatically approve application access to certain applications that are not considered to be security threat. However, such applications may be a security threat in combination with other applications and the system may adjust the system to not approve access to the application for a user that has access to the other application as well.

In various embodiments, in an instance in which the access approval for the applications of the potential malfeasant approval combination were manual, the system may determine whether the approval was appropriate. For example, the system may cause an execution of an access approval confirmation to the approving user (e.g., a manager or network administrator that approved the access to the application for the user).

In some embodiments, the system may receive a response to the access approval confirmation, in which the approving user indicates whether the user should be allowed access to the given application. The response to the access approval confirmation may also include information on the reason for the access approval (e.g., a user may be performing a role that is different than expected by the system). In some embodiments, in an instance in which the response to the access approval confirmation indicates that the access approval was correct, the system may determine that no potential malfeasant activity is indicated (e.g., changing the potential malfeasance indication to no potential malfeasance). Alternatively, the system may perform one or more actions to determine whether the access approval is appropriate (e.g., the system may not accept the approving user's word as final and still perform one or more investigation actions, such as determining whether the user is performing malfeasant activity with one or more applications of the potential malfeasant approval combination). In some embodiments, in an instance in which the response to the access approval confirmation indicates that the access approval was not correct, the system may restrict access for the user to the given application. Additionally, the system may perform one or more investigation actions to determine whether the user has performed any malfeasant activity (e.g., whether the user accessed data that the user otherwise should not be accessing).

The investigation action may include one or more actions to determine whether the user is performing malfeasant activity with one or more applications of the potential malfeasant approval combination. The system may determine whether the user is performing malfeasant activity with one or more applications of the potential malfeasant approval combination based on actions by the user. For example, the actions of the user may be compared to In various embodiments, the investigation action may include the operations of optional Block 310, optional Block 312, and/or optional Block 314, as discussed below. For example, the application activity information may indicate usage of the application by the user, such as what data the user accessed. The actions of the user are compared to a pattern of known malfeasant activity and/or a pattern of known non-malfeasant activity (e.g., activities by similarly situated users).

Referring now to optional Block 310 of FIG. 3, the method includes receiving application activity information for at least one of the first application or the second application. The application activity information includes one or more actions taken by an end-point device associated with the user on at least one of the first application or the second application. The application activity information may include browsing information (e.g., which pages of an application was accessed, how long the user remained on each page, etc.), data accessed (e.g., any data that was accessed on the application by the user), usage information (e.g., time spent on the application, time of day that application was accessed), information relating to other applications (e.g., which applications were accessed simultaneously and/or sequentially to the given application), and/or the like.

In various embodiments, the application activity information may be compared to expected user activity for the user. For example, the user activity may be compared to similarly situated users. In an example embodiment, a similar situated user may be a user that has the same or similar job title, same or similar ranking within the network, and/or the like. As such, the patterns of the one or more similar users may be used to determine the expected user activity. The user activity from the application activity information may be compared to the patterns of the activity of similar users to determine potential malfeasant activity. For example, a user with the same job title as the user in question may access a first application during specific hours and only visit certain portions of the application.

As such, in an instance in which the user operates completely differently than the similar user, the system may determine potential malfeasant activity. In some embodiments, the system may perform additional investigation actions. For example, the system may cause a transmission of a prompt to the user to provide a reason for the difference in activity (e.g., the user may be asked to provide a reason for the differences) and/or the system may cause a transmission of a notification to another user in the network (e.g., the manager of the user or a network administrator) to investigate the potential malfeasant activity (e.g., a manager may reach out to the user and inquire as to why the user is acting differently). In various embodiments, the system may receive additional information relating to the investigation (e.g., the manager or network administrator may provide a summary of findings based on a conversation with the user). As such, the system may be configured to update the malfeasant activity indication based on the additional information relating to the investigation (e.g., the system may analyze the information and determine whether the access is appropriate and/or malfeasance is likely).

In various embodiments, the application activity information may be compared to known malfeasant user activity. The patterns of known malfeasant user activity may be compared to the application activity information. Similarities between the known malfeasant user activity and the application activity information may indicate that malfeasant activity is likely. As such, the more similarities, the more likely that malfeasant activity is occurring. In an instance in which the known malfeasant user activity and the application activity information are the same or similar, the system may perform additional investigation actions as discussed above.

In various embodiments, the comparison of the application activity information to any other information (e.g., known malfeasant user activity and/or expected user activity for the user) may be used to determine a potential malfeasant activity confidence level. The potential malfeasant activity confidence level may be used to determine a potential malfeasant activity (e.g., in an instance in which the potential malfeasant activity confidence level is above a potential malfeasant activity confidence level threshold). The potential malfeasant activity confidence level may be based on the similarities to known malfeasant user activity and/or expected user activity for the user. For example, the more similarities the user activity has with one or more previous known malfeasant user activity, the higher the known potential malfeasant activity confidence level (e.g., indicating a higher likelihood of malfeasant activity) and/or the more similarities the user activity has with similarly situated users, the lower the potential malfeasant activity confidence level (e.g., indicating a lower likelihood of malfeasant activity).

Referring now to optional Block 312 of FIG. 3, the method includes determining a potential malfeasant activity based on the application activity information. As discussed above in reference to Block 310 of FIG. 3, the system may determine a potential malfeasant activity based on a comparison of the application activity information to user activity of one or more similarly situated users, previous known malfeasant activities, expected user activity, and/or the like. Additionally, the potential malfeasant activity may be determined based on the potential malfeasant activity confidence level (e.g., the user activity may be a potential malfeasant activity in an instance in which the potential malfeasant activity confidence level is above a potential malfeasant activity confidence level threshold).

Referring now to optional Block 314 of FIG. 3, the method includes determining a usage amount for at least one of the first application or the second application by the user. In various embodiments, the usage amount indicates an amount that given application was accessed, used, or opened on an end-point device associated with the user. The usage amount may be included in the application activity information discussed in reference to Block 310.

Referring now to optional Block 316 of FIG. 3, the method includes determining an access change action. In various embodiments, the access change action includes changing access for the user to at least one of the first application or the second application. In various embodiments, the method may also include causing an execution of the access change action (e.g., the system 130 may cause the access to one or more applications for a user to be adjusted).

The access change action may be in response to determining potential malfeasant activity and/or determining a given user has access to two applications that are considered a potential malfeasant approval combination. The access change action may be in response to the investigation action(s) discussed herein. In various embodiments, the access change action may be removing access for a user to one of the given applications (e.g., removing credentials for the user to access the given application). In some embodiments, the investigation action may include the access change action, either alone (e.g., access to at least one of the first application or second application are restricted in any instance in which the first application and the second application are considered a potential malfeasant approval combination) or in combination with other investigation actions (e.g., the investigation actions discussed herein that includes determining whether the user is potentially performing malfeasant activity and/or determining whether approval for access was proper).

In various embodiments, the access change action may include a reduction in access level for the user to one or more applications. For example, the user may have certain access within an application (e.g., the first application and/or the second application) restricted in order to protect against malfeasant activity. In such an example, the user may still have some access to the application (e.g., the user may be able to use the given application, but not allowed to access certain data within an application).

In various embodiments, the access change action is based on the execution of the investigation action. For example, access for the user to at least one of the first application or the second application is restricted in an instance at least one of the first application or the second application was not approved for the user. As discussed herein, the system may determine how the user received approval for access to one or more of the applications in the given potential malfeasant approval combination. In an instance in which the access for the given application was not approved (e.g., the system should not have approved the access request, the manager or network administrator did not approve the access request, the manager or network administrator mistakenly approved the access request, etc.), the access change action may be to restrict or completely eliminate access to one or more of the applications (e.g., the user may have been mistakenly approved for access to the first application and the access to the first application may be removed).

In various embodiments, the ML/AI model used in various embodiments may be updated based on the operations discussed herein. For example, the information determined relating to the user (e.g., potential malfeasant activity) may be used in order to determine future malfeasant activity (e.g., as a potential malfeasant activity to compare future activity). As such, determinations discussed herein may be used to train and/or update the ML/AI models used herein.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for secure network access management using a dynamic constraint specification matrix, the system comprising:
at least one non-transitory storage device containing instructions; and
at least one processing device coupled to the at least one non-transitory storage device, wherein the at least one processing device, upon execution of the instructions, is configured to:
receive an application access log associated with a user of a network, wherein the application access log comprises one or more approved applications for which the user has access;
determine a potential malfeasance indication for the user based on the application access log,
wherein the potential malfeasance indication is based on a first application of the one or more approved applications and a second application of the one or more approved applications that correspond to one of one or more potential malfeasant approval combinations, and
wherein each of the one or more potential malfeasant approval combinations comprises two or more applications that one or more users on the network should not be authorized for access simultaneously; and
cause an execution of an investigation action, wherein the investigation action determines whether access for at least one of the first application or the second application was approved for the user.

2. The system of claim 1, wherein the at least one processing device, upon execution of the instructions, is configured to determine the one or more potential malfeasant approval combinations, wherein each of the one or more potential malfeasant approval combinations comprises two or more applications that one or more users on the network should not be authorized for access simultaneously.

3. The system of claim 1, wherein the at least one processing device, upon execution of the instructions, is configured to determine a usage amount for at least one of the first application or the second application by the user, wherein the usage amount indicates an amount that given application was accessed, used, or opened on an end-point device associated with the user.

4. The system of claim 1, wherein the at least one processing device, upon execution of the instructions, is configured to:
receive application activity information for at least one of the first application or the second application, wherein the application activity information comprises one or more actions taken by an end-point device associated with the user on at least one of the first application or the second application; and
determine a potential malfeasant activity based on the application activity information.

5. The system of claim 1, wherein the at least one processing device, upon execution of the instructions, is configured to determine an access change action, wherein the access change action comprises changing access for the user to at least one of the first application or the second application.

6. The system of claim 5, wherein the access change action is based on the execution of the investigation action, wherein access for the user to at least one of the first application or the second application is restricted in an instance at least one of the first application or the second application was not approved for the user.

7. The system of claim 4, wherein the at least one processing device, upon execution of the instructions, is configured to determine an access change action, wherein the access change action comprises changing access for the user to at least one of the first application or the second application in an instance in which the potential malfeasant activity is determined.

8. A computer program product for secure network access management using a dynamic constraint specification matrix, the computer program product comprising at least one non-transitory computer-readable medium having computer-readable program code portions embodied therein, the computer-readable program code portions comprising one or more executable portions configured to:
receive an application access log associated with a user of a network, wherein the application access log comprises one or more approved applications for which the user has access;
determine a potential malfeasance indication for the user based on the application access log,
wherein the potential malfeasance indication is based on a first application of the one or more approved applications and a second application of the one or more approved applications that correspond to one of one or more potential malfeasant approval combinations, and
wherein each of the one or more potential malfeasant approval combinations comprises two or more applications that one or more users on the network should not be authorized for access simultaneously; and
cause an execution of an investigation action, wherein the investigation action determines whether access for at least one of the first application or the second application was approved for the user.

9. The computer program product of claim 8, wherein the computer-readable program code portions comprising one or more executable portions are also configured to determine the one or more potential malfeasant approval combinations, wherein each of the one or more potential malfeasant approval combinations comprises two or more applications that one or more users on the network should not be authorized for access simultaneously.

10. The computer program product of claim 8, wherein the computer-readable program code portions comprising one or more executable portions are also configured to determine a usage amount for at least one of the first application or the second application by the user, wherein the usage amount indicates an amount that given application was accessed, used, or opened on an end-point device associated with the user.

11. The computer program product of claim 8, wherein the computer-readable program code portions comprising one or more executable portions are also configured to:
receive application activity information for at least one of the first application or the second application, wherein the application activity information comprises one or more actions taken by an end-point device associated with the user on at least one of the first application or the second application; and
determine a potential malfeasant activity based on the application activity information.

12. The computer program product of claim 8, wherein the computer-readable program code portions comprising one or more executable portions are also configured to determine an access change action, wherein the access change action comprises changing access for the user to at least one of the first application or the second application.

13. The computer program product of claim 12, wherein the access change action is based on the execution of the investigation action, wherein access for the user to at least one of the first application or the second application is restricted in an instance at least one of the first application or the second application was not approved for the user.

14. The computer program product of claim 11, wherein the computer-readable program code portions comprising one or more executable portions are also configured to determine an access change action, wherein the access change action comprises changing access for the user to at least one of the first application or the second application in an instance in which the potential malfeasant activity is determined.

15. A method for secure network access management using a dynamic constraint specification matrix, the method comprising:
receiving an application access log associated with a user of a network, wherein the application access log comprises one or more approved applications for which the user has access;
determining a potential malfeasance indication for the user based on the application access log,
wherein the potential malfeasance indication is based on a first application of the one or more approved applications and a second application of the one or more approved applications that correspond to one of one or more potential malfeasant approval combinations, and
wherein each of the one or more potential malfeasant approval combinations comprises two or more applications that one or more users on the network should not be authorized for access simultaneously; and
causing an execution of an investigation action, wherein the investigation action determines whether access for at least one of the first application or the second application was approved for the user.

16. The method of claim 15, further comprising determining the one or more potential malfeasant approval combinations, wherein each of the one or more potential malfeasant approval combinations comprises two or more applications that one or more users on the network should not be authorized for access simultaneously.

17. The method of claim 15, further comprising determining a usage amount for at least one of the first application or the second application by the user, wherein the usage amount indicates an amount that given application was accessed, used, or opened on an end-point device associated with the user.

18. The method of claim 15, further comprising:
receiving application activity information for at least one of the first application or the second application, wherein the application activity information comprises one or more actions taken by an end-point device associated with the user on at least one of the first application or the second application; and
determining a potential malfeasant activity based on the application activity information.

19. The method of claim 15, further comprising determining an access change action, wherein the access change action comprises changing access for the user to at least one of the first application or the second application, in an instance at least one of the first application or the second application was not approved for the user.

20. The method of claim 18, further comprising determining an access change action, wherein the access change action comprises changing access for the user to at least one of the first application or the second application in an instance in which the potential malfeasant activity is determined.
